(19) United States
(12) Patent Application Publication
(10) Pub. No.: US 2015/0237401 A1
(43) Pub. Date: Aug. 20, 2015

(54) REPRODUCING DEVICE, REPRODUCING METHOD, RECEIVING APPARATUS, AND REPRODUCING SYSTEM FOR SPECIFYING VIEWING RECORD OF PROGRAM CONTENT REMOTELY VIEWED BY USER

(71) Applicant: SHARP KABUSHIKI KAISHA, Osaka (JP)

(72) Inventors: Keiu MORIMOTO, Osaka-shi (JP); Shinichiro KINOSHITA, Osaka-shi (JP)

(73) Assignee: SHARP KABUSHIKI KAISHA, Osaka (JP)

(21) Appl. No.: 14/622,172

(22) Filed: Feb. 13, 2015

(30) Foreign Application Priority Data
Feb. 14, 2014 (JP) 2014-027024

(51) Int. Cl. H04N 21/466; H04N 21/414; H04N 7/173; H04N 21/24; H04H 60/40; H04N 21/442

(52) U.S. Cl. CPC H04N 21/4667; H04H 60/40; H04N 21/44222; H04N 7/17309; H04N 21/2407; H04N 21/41407

(57) ABSTRACT

A smart phone having a control section is provided. The control section remotely accesses a television, which is connected with a home LAN, so as to obtain a program content from the television, and reproduces the program content thus obtained. Then, the control section transmits, to a log collecting server, a reproduction log that relates to reproduction of the program content.

### TECHNICAL FIELD

The present invention mainly relates to a reproducing device for reproducing a content.

### BACKGROUND ART

This Nonprovisional application claims priority under 35 U.S.C. §119 on Patent Application No. 2014-027024 filed in Japan on Feb. 14, 2014, the entire contents of which is hereby incorporated by reference.

Recently, some of broadcast receiving devices available in market have a function to wirelessly transfer a received program content to a mobile terminal that can reproduce the program content. This function allows a user to view a program content with the use of a mobile terminal instead of a television.

In accordance with such increase in variety of style of viewing program contents, a technique has been proposed to more accurately grasp an audience rating of a program content. Moreover, a technique has also been proposed to present information for figuring out which part of a program content is popular (see Patent Literature 1).

### CITATION LIST

### Patent Literature

### [Patent Literature 1]

Japanese Patent Application Publication Tokukai No. 2010-114723 (Publication date: May 20, 2010)

### SUMMARY OF INVENTION

### Technical Problem

A viewing style is possible in which a user remotely views, with a mobile terminal, a program content which has been received by a broadcast receiving device that is generally placed in a house.

With regard to this, a record of viewing a program content, which has been remotely viewed by a user, could not be grasped with the use of the conventional configuration.

The present invention is accomplished in view of the problems, and its main object is to provide a reproducing device that can be used to specify a record of viewing a program content which has been remotely viewed by a user.

### Solution to Problem

In order to attain the object, a reproducing device in accordance with an aspect of the present invention includes: an obtaining section that obtains a program content from an apparatus, which is connected with a network, by remotely accessing the apparatus; a reproducing section that reproduces the program content which has been obtained by the obtaining section; and a transmitting section that transmits, to a server, a reproduction log which relates to reproduction of the program content carried out by the reproducing section.

### Advantageous Effects of Invention

The reproducing device in accordance with an aspect of the present invention can be used to specify a record of viewing a program content which has been remotely viewed by a user.

### BRIEF DESCRIPTION OF DRAWINGS

FIG. 1 is a system block diagram illustrating a reproducing system in accordance with Embodiments 1 through 3 of the present invention.

FIG. 2 is a block diagram illustrating a hardware configuration of a television receiver in accordance with Embodiments 1 through 3 of the present invention.

FIG. 3 is a functional block diagram illustrating main functions achieved by a CPU of the television receiver in accordance with Embodiments 1 through 3 of the present invention.

FIG. 4 is a block diagram illustrating a hardware configuration of a smart phone in accordance with Embodiments 1 through 3 of the present invention.

FIG. 5 is a functional block diagram illustrating main functions achieved by a CPU of the smart phone in accordance with Embodiments 1 through 3 of the present invention.

FIG. 6 is a block diagram illustrating a hardware configuration of two servers (remote access server and log collecting server) in accordance with Embodiments 1 through 3 of the present invention.

FIG. 7 is a view relating to Embodiments 1 through 3 of the present invention and schematically illustrating a database table stored in a remote access server.

FIG. 8 is a view including a flowchart indicating operation of a television receiver and a flowchart indicating operation of a smart phone, in accordance with Embodiments 1 through 3 of the present invention.

FIG. 9 is a view including two flowcharts corresponding to respective two concrete examples of a step in the flowchart indicating operation of the smart phone in FIG. 8.

FIG. 10 is a view relating to Embodiments 1 through 3 of the present invention and schematically illustrating information which is to be transmitted from a television to a smart phone that is remotely accessing the television.

FIG. 11 is a view relating to Embodiment 1 of the present invention and schematically illustrating a reproduction log generated by a smart phone that remotely reproduces a program content.

FIG. 12 is a view relating to Embodiment 1 of the present invention and is a view for explaining which part of a program was viewed by a user of the smart phone that has generated the reproduction log in FIG. 11.

FIG. 13 is a flowchart illustrating still another concrete example of a step in the flowchart indicating operation of the smart phone in FIG. 8.

FIG. 14 is a view relating to Embodiment 2 of the present invention and schematically illustrating a reproduction log generated by a smart phone that remotely reproduces a program content.

FIG. 15 is a view relating to Embodiment 3 of the present invention and schematically illustrating a reproduction log generated by a smart phone that remotely reproduces a program content.

FIG. 16 is a view relating to Embodiment 3 of the present invention and is a view for explaining which part of a program was viewed by a user of the smart phone that has generated the reproduction log in FIG. 15.

FIG. 17 is a view relating to Embodiments 1 through 3 of the present invention and schematically illustrating view information data that has been generated by combining reproduction logs collected by a log collecting server from a plurality of terminals (such as smart phones in Embodiments 1 through 3).

FIG. 18 is a system block diagram illustrating a reproducing system in accordance with Embodiment 4 of the present invention.

### DESCRIPTION OF EMBODIMENTS

### Embodiment 1

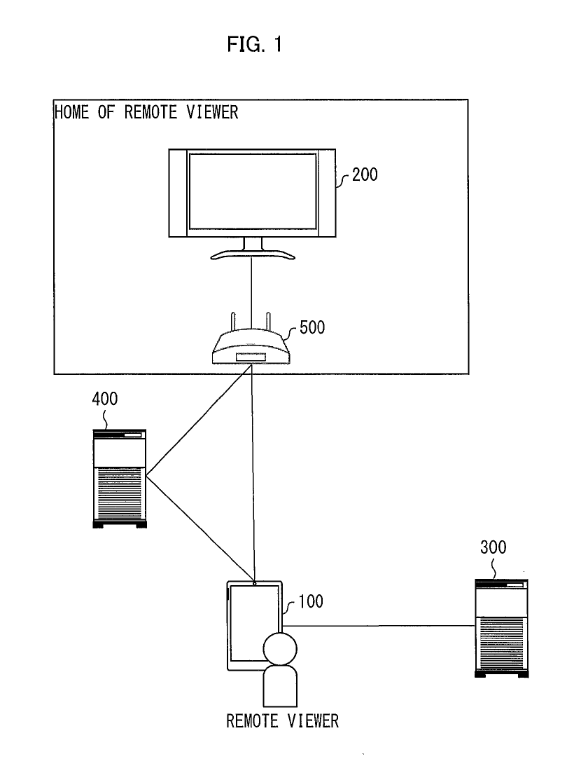

The following description will discuss a reproducing system in accordance with an embodiment of the present invention with reference to FIGS. 1 through 13.

(Outline of Reproducing System)

The following description will discuss an outline of a reproducing system of the present embodiment with reference to FIG. 1. FIG. 1 is a system block diagram illustrating the reproducing system in accordance with the present embodiment.

As illustrated in FIG. 1, the reproducing system of the present embodiment includes a smart phone 100, a television receiver 200 (hereinafter, simply referred to as “television 200”), a log collecting server 300, a remote access server 400, and a router 500.

The television 200 is connected with a local area network in a home of a user of the smart phone 100. The router 500 is provided in the home of the user and enables communication between the local area network and an external network.

The television 200 has a function to record a program content which is received by the television 200. When the function is valid, the television 200 sets a storage section, which is included in the television 200, as a destination to which a program content and a recording list are to be stored. Then, when the smart phone 100 has accepted operation for remotely reproducing a program content stored in the television 200, the television 200 carries out (i) a process for establishing remote connection with the smart phone 100 and (ii) a process for transmitting data (such as a recording list and the program content) which is necessary for the smart phone 100 to carry out remote reproduction.

The log collecting server 300 and the remote access server 400 are provided on a cloud side.

The remote access server 400 is used to achieve remote access from the smart phone 100 (slave unit) to the television 200 (master unit). The smart phone 100, which has become able to remotely access the television 200, remotely reproduce a program content which has been received by and recorded on the television 200. Then, the smart phone 100 generates a reproduction log while remotely reproducing the program content.

The log collecting server 300 receives, from the smart phone 100, the reproduction log thus generated. Further, the log collecting server 300 (i) generates view information data by combining reproduction logs collected from a plurality of terminals including the smart phone 100 and (ii) specifies program viewing records of users of respective terminals and an audience rating of a program by analyzing the view information data.

The description above has discussed the outline of the reproducing system.

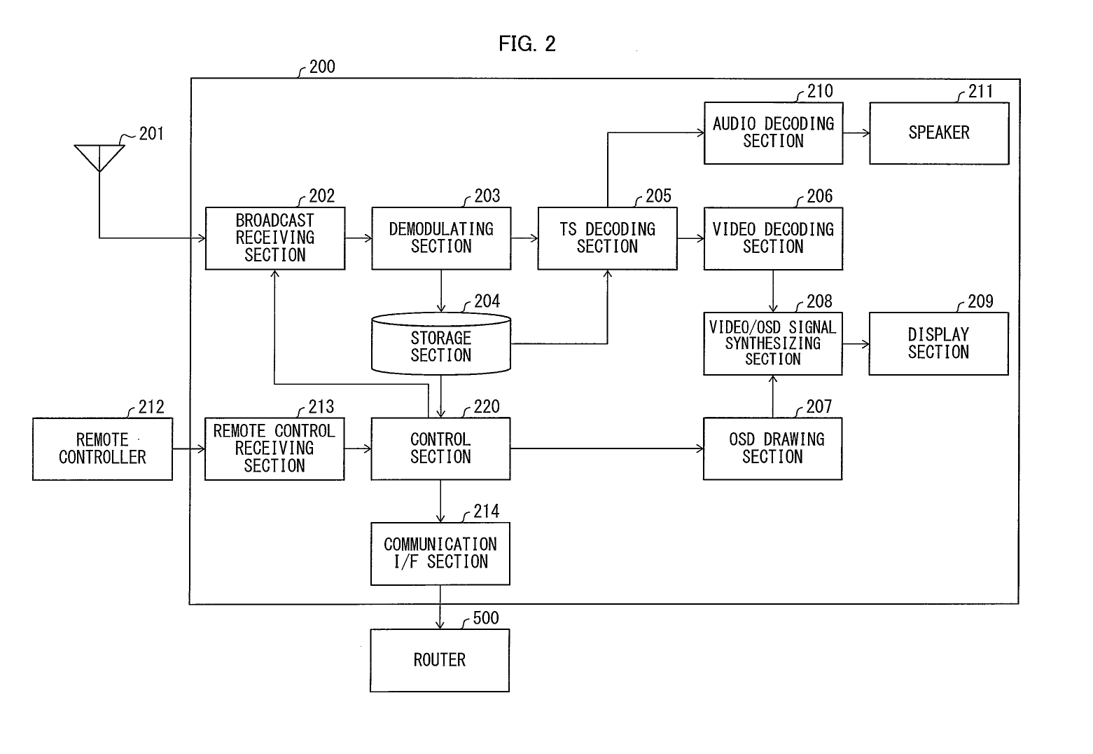

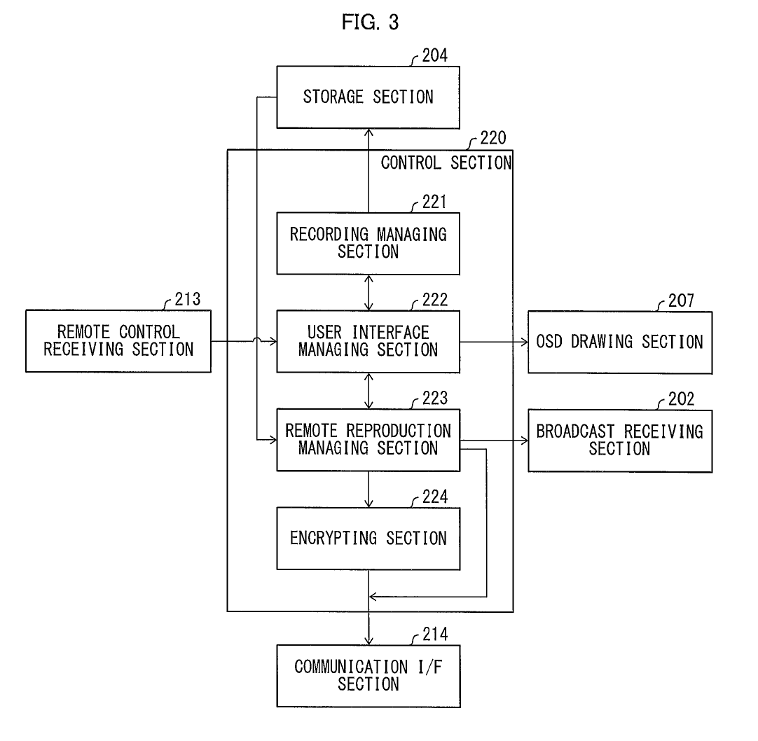

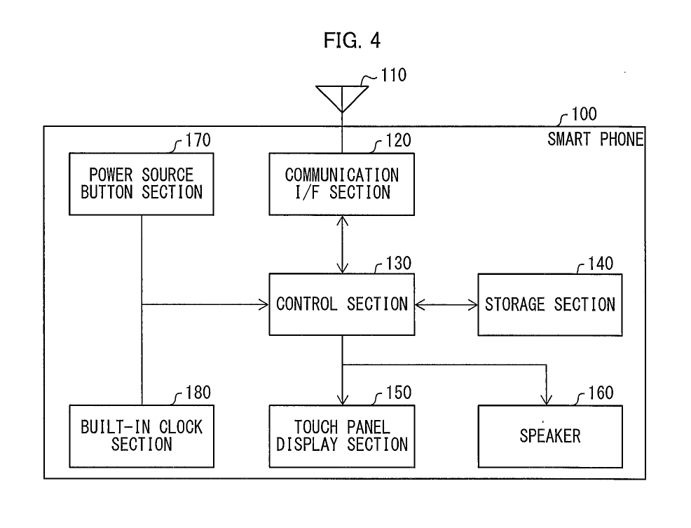

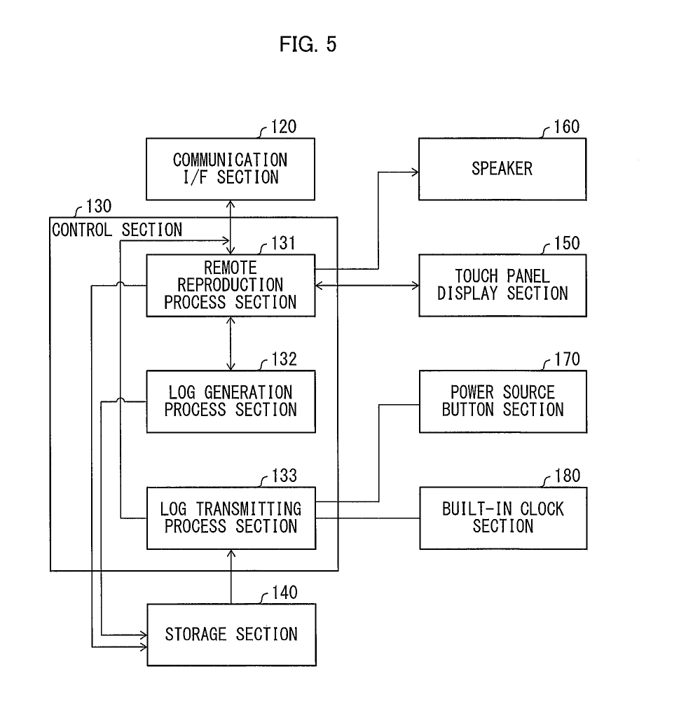

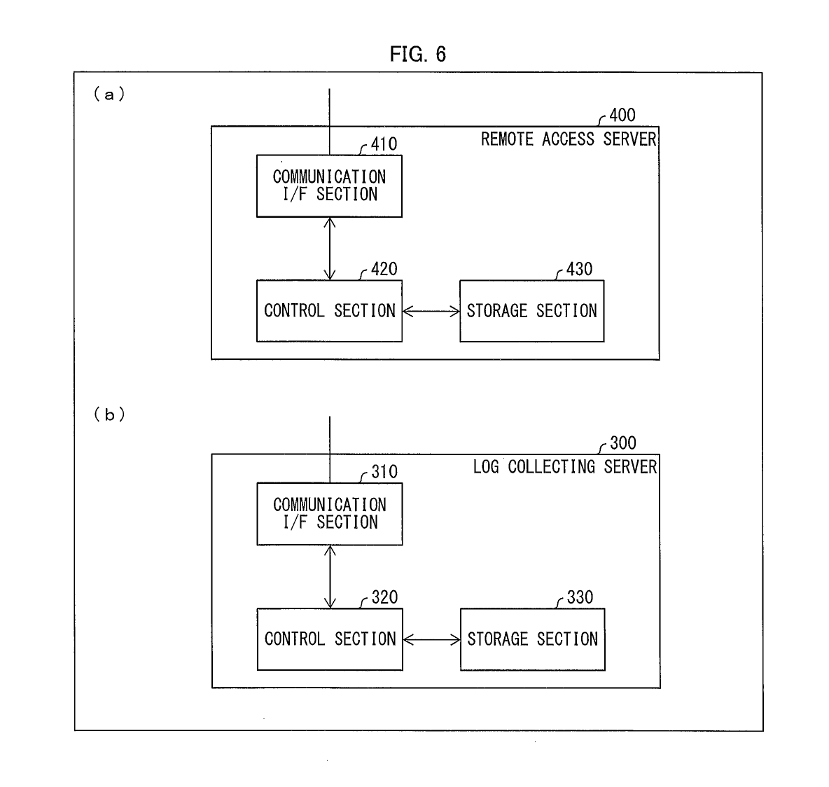

The following description will discuss configurations of main devices included in the reproducing system of the present embodiment with reference to FIGS. 2 through 6. FIG. 2 is a block diagram illustrating a hardware configuration of the television 200. FIG. 3 is a functional block diagram illustrating main functions achieved by a CPU in the television 200. FIG. 4 is a block diagram illustrating a hardware configuration of the smart phone 100. FIG. 5 is a functional block diagram illustrating main functions achieved by a CPU in the smart phone 100. FIG. 6 is a block diagram illustrating a hardware configuration of the remote access server 400 and the log collecting server 300.

First, the following describes hardware configurations of respective devices with reference to FIG. 2, FIG. 4, and FIG. 6.

(Hardware Configuration of Television 200)

As illustrated in FIG. 2, the television 200 includes a broadcast receiving section 202, a demodulating section 203, a storage section 204, a TS decoding section 205, a video decoding section 206, an OSD drawing section 207, a video/OSD signal synthesizing section 208, a display section 209, an audio decoding section 210, a speaker 211, a remote control receiving section 213, a communication I/F section 214, and a control section 220.

The broadcast receiving section 202 is a tuner that receives, via an antenna 201, a broadcast wave of a channel that has been selected by the user.

The demodulating section 203 is a demodulating LSI that demodulates a broadcast wave, which has been received by the broadcast receiving section 202, so as to extract a program content (specifically, TS (transport stream) data of the program content) from the broadcast wave.

The storage section 204 is a storage medium on which a program content, whose recording has been instructed by the user, is recorded. In the present embodiment, the storage section 204 is a hard disk drive. Note, however, that the storage section 204 can be a flash memory. Alternatively, an optical disk drive (such as a BD drive) can be provided instead of the storage section 204 such that a program content is recorded on an optical disk inserted in the optical disk drive.

The TS decoding section 205 is a decoder LSI that decodes TS data supplied from the demodulating section 203. TS decoding section 205 (i) supplies a video ES (elementary stream), which has been obtained by decoding, to the video decoding section 206 and (ii) supplies an audio ES, which has been obtained by decoding, to the audio decoding section 210.

The video decoding section 206 is a decoder LSI that (i) decodes a video ES so as to generate a video signal representing a program video and (ii) supplies the video signal to the video/OSD signal synthesizing section 208.

The OSD drawing section 207 is configured by an OSD processor. The OSD drawing section 207 (i) generates an OSD signal (i.e., on-screen display signal) representing an OSD image (i.e., user interface image) that corresponds to a content of remote controller operation and (ii) supplies the OSD signal to the video/OSD signal synthesizing section 208.

The video/OSD signal synthesizing section 208 is configured by a video processor. The video/OSD signal synthesizing section 208 synthesizes a video signal of a program video and an OSD signal and controls the display section 209 to display the program video and an OSD image.

The display section 209 is a display that displays a program video and an OSD image.

The audio decoding section 210 is a decoder LSI that generates an audio signal by decoding an audio ES.

The speaker 211 outputs program audio represented by the audio signal supplied from the audio decoding section 210.

The remote control receiving section 213 receives an operation signal from the remote controller 212.

The communication I/F section 214 is a LAN terminal to which a LAN cable is connected. Note that the communication I/F section 214 can be a wireless LAN interface.

The control section 220 is a CPU. The control section 220 executes various processes by reading out various applications that are stored in the storage section 204.

(Hardware Configuration of Smart Phone 100)

As illustrated in FIG. 4, the smart phone 100 includes an antenna 110, a communication I/F section 120, a control section 130, a storage section 140, a touch panel display section 150, a speaker 160, a power source button section 170, and a built-in clock section 180.

The antenna 110 transmits a radio wave to or receives a radio wave from a wireless base station of a carrier.

The communication I/F section 120 is a communication interface which includes (i) a communication module for carrying out communication (e.g., 3G communication, 3.5G communication (such as HSPA+), 3.9G communication (such as WiMAX or LTE), 4G communication (such as WiMAX2 or LTE-Advanced)) with the wireless base station of the carrier and (ii) a communication module that supports wireless LAN connection.

The control section 130 is a CPU. The control section 130 executes various processes by reading out various applications stored in the storage section 140.

The storage section 140 is a storage medium for storing data such as various applications and reproduction logs.

The touch panel display section 150 is a display for displaying a program video of a program content which is remotely reproduced.

The speaker 160 outputs program audio of the program content which is remotely reproduced.

The power source button section 170 is a button for switching ON/OFF of a power source of the smart phone 100.

The built-in clock section 180 is a built-in clock indicating a current time.

(Hardware Configuration of Log Collecting Server 300)

As illustrated in (b) of FIG. 6, the log collecting server 300 includes a communication I/F section 310, a control section 320, and a storage section 330.

The communication I/F section 310 is an Ethernet (Registered Trademark) interface provided for carrying out communication with the smart phone 100.

The control section 320 is a CPU. The control section 320 generates view information data by combining reproduction logs collected from a plurality of terminals including the smart phone 100.

The storage section 330 is a storage medium for storing view information data. In the present embodiment, the storage section 330 is a hard disk drive. Note, however, that the storage section 330 can be a flash memory.

(Hardware Configuration of Remote Access Server 400)

As illustrated in (a) of FIG. 6, the remote access server 400 includes a communication I/F section 410, a control section 420, and a storage section 430.

The communication I/F section 410 is an interface provided for carrying out communication with a receiving device (such as the television 200) and a terminal (such as the smart phone 100) which has requested remote access to the receiving device.

The control section 420 is a CPU. The control section 420 carries out a process for establishing remote connection between a receiving device and a terminal which has requested remote access to the receiving device.

The storage section 430 is a storage medium in which a predetermined database table is stored. The database table is referred by the control section 420 in operation for establishing the remote connection.

The description above has discussed the hardware configurations of the respective devices.

The following description will discuss functions achieved by the CPUs respectively in the television 200 and the smart phone 100, with reference to FIG. 3 and FIG. 5.

(Functions Achieved by CPU in Television 200)

As illustrated in FIG. 3, the control section 220 of the television 200 servers as a recording managing section 221, a user interface managing section 222, a remote reproduction managing section 223, and an encrypting section 224 by reading out various programs.

The recording managing section 221 carries out various processes relating to recording of a program content.

For example, when the remote controller 212 has accepted operation for recording a program content, the recording managing section 221 carries out a process for causing the program content, which has been extracted by the demodulating section 203, to be recorded on the storage section 204. Moreover, for example, when recording of the program content has been finished, the recording managing section 221 updates a recording list stored in the storage section 204. Moreover, for example, when the remote controller 212 has accepted operation for displaying the recording list, the recording managing section 221 reads out the recording list from the storage section 204 and requests the user interface managing section 222 to prepare a UI image that contains the recording list.

When the remote controller 212 has accepted operation for changing a UI, the user interface managing section 222 (i) prepares a UI image that corresponds to an operation content and (ii) supplies the UI image thus prepared to the OSD drawing section 207.

The remote reproduction managing section 223 carries out (i) a process for establishing remote connection with the smart phone 100 and (ii) a process for transmitting, via the communication I/F section 214, data (such as a program content requested from the smart phone 100) that is necessary for the smart phone 100 to carry out remote reproduction.

The encrypting section 224 encrypts a program content to which an instruction on encrypting has been given from the smart phone 100. Note that the encrypting section 224 can be configured by a dedicated encrypting LSI instead of the CPU.

(Functions Achieved by CPU in Smart Phone 100)

As illustrated in FIG. 5, the control section 130 of the smart phone 100 serves as a remote reproduction process section 131, a log generation process section 132, and a log transmitting process section 133 by reading out a predetermined content reproducing application (hereinafter, referred to as “target application”) from the storage section 140.

The remote reproduction process section 131 carries out a process for establishing remote connection between the smart phone 100 and the television 200. After the remote connection has been established, the remote reproduction process section 131 (i) remotely accesses the television 200 and obtains, from the television 200, a program content to which an instruction on reproduction has been given from the user, and then (ii) reproduces the program content thus obtained.

The log generation process section 132 generates a reproduction log that relates to remote reproduction of a program content.

Specifically, the log generation process section 132 newly generates a file (empty file) of a reproduction log each time the log transmitting process section 133 transmits the file of the reproduction log to the log collecting server 300. When the touch panel display section 150 has accepted an instruction on remotely reproducing a program content, the log generation process section 132 updates the file each time a reproduction status changes.

Each time the power source button section 170 has accepted operation to turn OFF the power source of the smart phone 100, the log transmitting process section 133 transmits, to the log collecting server 300, a file of a latest reproduction log.

The description above has discussed the functions achieved by the CPUs respectively in the television 200 and the smart phone 100.

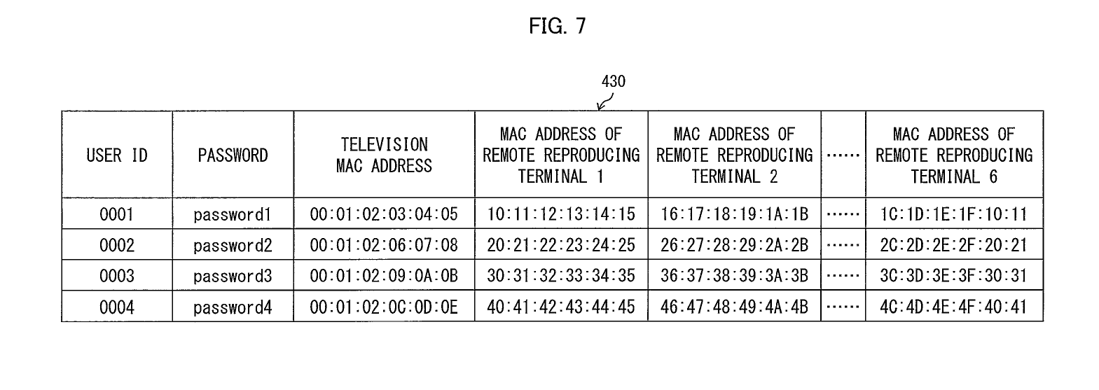

The following description will discuss, with reference to FIG. 7, operation which is carried out by the reproducing system in order to establish remote connection between the smart phone 100 and the television 200. FIG. 7 is a view schematically exemplifying a content in a database table which is stored in the remote access server 400 immediately before the operation starts. In the database table, an apparatus ID (specifically, MAC address) of a television is associated with an MAC address of a terminal which can remotely access the television.

Note that an MAC address of the smart phone 100 and an MAC address of the television 200 are not registered on the database table of FIG. 7. That is, before the operation described below starts, the smart phone 100 and the television 200 are assumed to be not remotely connectable to each other. Moreover, it is assumed that the user has connected the smart phone 100 to a home local area network with which the television 200 is being connected.

(Operation Carried Out by Reproducing System for Establishing Remote Connection Between Smart Phone 100 and Television 200)

It is assumed that the television 200 has accepted (i) operation for registering a pair of the smart phone 100 and the television 200 on the remote access server 400 or (ii) operation for turning ON the power source of the television 200.

The remote reproduction managing section 223 reads out a predetermined URL (i.e., URL for registering a master unit) which is stored in the storage section 204 in advance, and accesses the URL thus read out. Consequently, the remote reproduction managing section 223 is connected to the remote access server 400 and transmits an MAC address of the television 200 to the remote access server 400.

When the remote access server 400 has received the MAC address of the television 200, the control section 420 judges whether or not the MAC address thus received is stored in the database table. In a case where the control section 420 determines that the received MAC address is not stored in the database table (that is, in a case where the MAC address of the television 200 is to be registered on the remote access server 400 for the first time), the control section 420 registers, on the database table, a new record (in the example of FIG. 7, a record in which a “user ID” field value is “0005” and a “television MAC address” field value is the MAC address of the television 200) and preferably carries out the following process.

That is, the control section 420 transmits, to the television 200, html data which has been requested from the television 200. The remote reproduction managing section 223 of the television 200 displays a UI screen represented by the html data. The UI screen includes a user ID, a password input box, and a transmit button.

When a password has inputted and the transmit button has been pressed, the remote reproduction managing section 223 transmits the inputted password to the remote access server 400. The control section 420 causes the inputted password to be stored in a “password” field of the new record.

Next, it is assumed that the user has activated a target application installed in the smart phone 100 and has then carried out operation, with respect to the activated target application, for registering the smart phone 100 on the remote access server 400.

The remote reproduction process section 131 reads out a setting file of the target application which file is stored in the storage section 140 in advance, and then accesses a predetermined URL (i.e., URL for registering a slave unit) described in the setting file. Consequently, the remote reproduction process section 131 is connected to the remote access server 400 and transmits an MAC address of the smart phone 100 to the remote access server 400.

When the remote access server 400 has received the MAC address of the smart phone 100, the control section 420 judges whether or not there is a television which (i) is connected with the remote access server 400 and (ii) belongs to a LAN to which the smart phone 100 belongs.

As a result, the control section 420 determines that the television 200 exists as such a television, and registers the MAC address of the smart phone 100 on the record on which the MAC address of the television 200 is registered.

By the process described above, the pair of the smart phone 100 and the television 200 is registered on the remote access server 400.

Next, it is assumed that the television 200 has accepted operation for becoming in a state in which the television 200 can accept a request for remote reproduction from the smart phone 100.

The remote reproduction managing section 223 reads out a predetermined URL (i.e., URL to be accessed by the master unit for establishing remote connection) which is stored in the storage section 204 in advance, and then accesses the URL thus read out. Consequently, the remote reproduction managing section 223 is connected to the remote access server 400 and transmits the MAC address of the television 200 to the remote access server 400. Note that the television 200 preferably maintains connection with the remote access server 400 until the power source of the television 200 is turned OFF.

Subsequently, it is assumed that the user goes out while having the smart phone 100, and then carries out operation with respect to the smart phone 100 to remotely access the television 200 away from home (e.g., in a foreign country or at a friend's house).

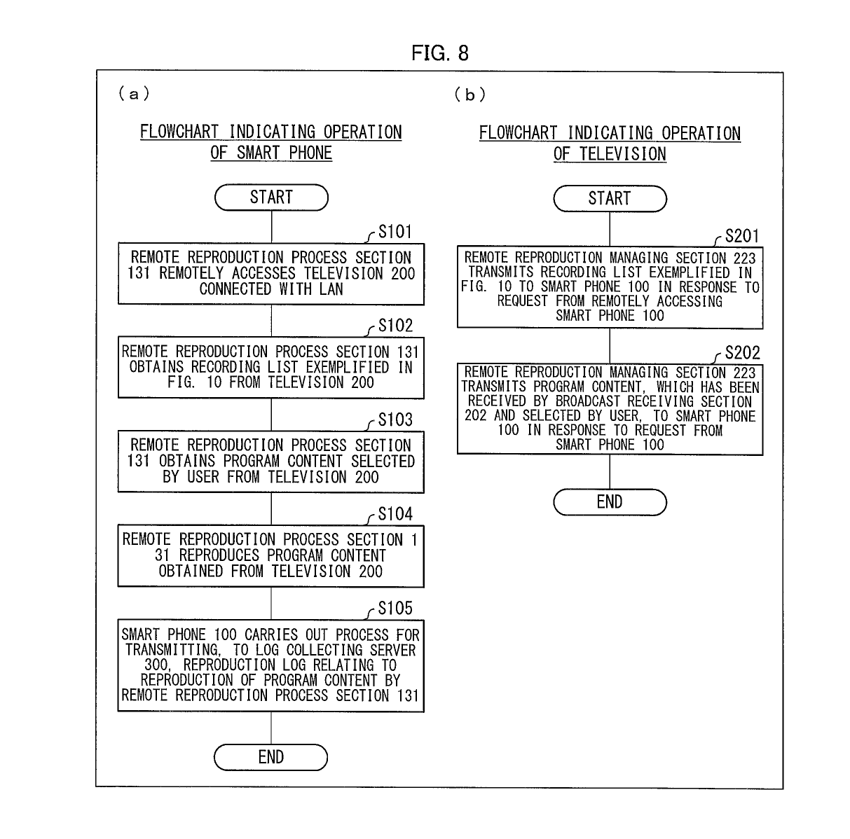

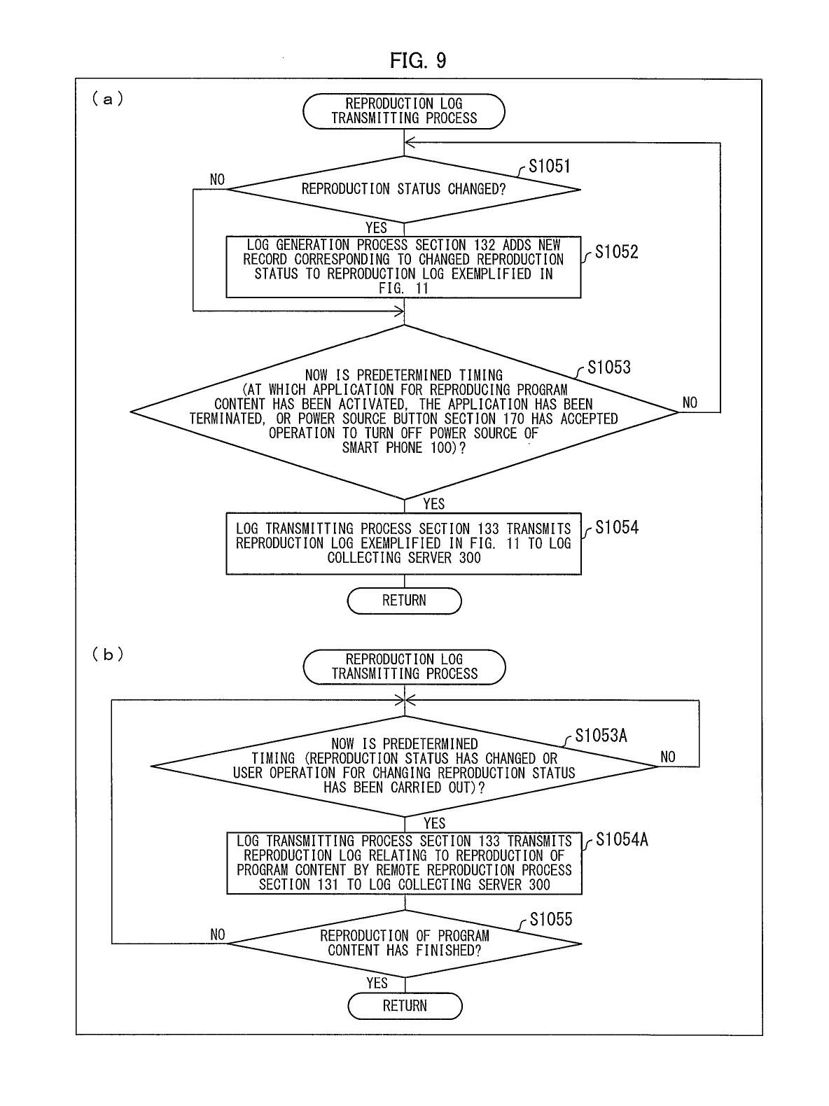

The following description will discuss operation of the smart phone 100 and the television 200 carried out after the smart phone 100 has accepted the above described operation, with reference to FIG. 8 and (a) of FIG. 9.

(a) of FIG. 8 is a flowchart illustrating operation of the smart phone 100. (b) of FIG. 8 is a flowchart illustrating operation of the television 200. (a) of FIG. 9 is a flowchart illustrating a concrete example of a process (step S105) in the flowchart of (a) of FIG. 8.

Upon receipt of the above described operation, the smart phone 100 carries out a process of a step S101. Specifically, the smart phone 100 carries out a series of processes described below.

That is, the remote reproduction process section 131 accesses a predetermined URL (i.e., URL to be accessed by the slave unit for establishing remote connection) which is described in the setting file stored in the storage section 140. Consequently, the remote reproduction process section 131 is connected to the remote access server 400 and then transmits the MAC address of the smart phone 100 to the remote access server 400.

When the remote access server 400 has received the MAC address of the smart phone 100, the control section 420 judges whether or not a record, which contains the MAC address of the smart phone 100 and the MAC address of the television, exists in the database table.

Consequently, the control section 420 determines that a record (hereinafter, referred to as “relevant record”) which contains the MAC address of the smart phone 100 and the MAC address of the television 200 exists in the database table. Then, the control section 420, which has obtained the judgment result, transmits, to the smart phone 100, html data requested from the smart phone 100.

The remote reproduction process section 131 of the smart phone 100 displays a UI screen represented by the html data. The UI screen includes a user ID input box, a password input box, and a transmit button.

When the user ID and the password have been inputted and the transmit button has been pressed, the remote reproduction process section 131 transmits the inputted user ID and password to the remote access server 400.

Then, the control section 420 judges whether or not a value of the “user ID” field in the relevant record is identical with the inputted user ID and a value of the “password” field in the relevant record is identical with the inputted password (that is, whether or not authentication has succeeded).

In a case where the control section 420 has determined that the authentication has succeeded, the control section 420 transmits an IP address (global address) and a connection destination port number of the smart phone 100 to the television 200 which is being connected with the remote access server 400.

Note that, in a case where the television 200 is not connected with the remote access server 400 at a time point at which the control section 420 obtains a judgment result of success in authentication, the control section 420 can notify the smart phone 100 of failure in remote access. Alternatively, in a case where the control section 420 has obtained a judgment result of failure in authentication, the control section 420 can notify the smart phone 100 of the failure in authentication.

When the television 200 has received the IP address and the connection destination port number of the smart phone 100, the remote reproduction managing section 223 establishes connection with the smart phone 100 with reference to the IP address and the connection destination port number.

By carrying out the operation above described, the reproducing system can establish remote connection between the smart phone 100 and the television 200 without (i) burdening the user with complicated work, i.e., filtering rule setting of the router 500 (specifically, work for allowing access, which is directed from a WAN side to a particular port number, to pass through to a LAN side) and (ii) decreasing a security level in the LAN.

The description above has discussed an example of operation which the reproducing system carries out for establishing remote connection between the smart phone 100 and the television 200. The following description will discuss modification examples of this operation.

### Modification Example 1

With regard to the above described operation and operations in Modification Examples 2 and 3, serial numbers can be used instead of the MAC addresses as the apparatus IDs.

### Modification Example 2

The database table does not need to include the user ID field and the password field.

In this case, the control section 420 can operate as below before the step of registering the pair of the smart phone 100 and the television 200 on the remote access server 400.

That is, in a case where the control section 420 has determined that the MAC address of the television 200 is not stored in the database table, the control section 420 (i) registers, on the database table, a record in which a value of the “television MAC address” field is the MAC address of the television 200 and then (ii) does not transmit, to the television 200, html data representing a UI screen containing a user ID, a password input box, and a transmit button.

Moreover, the control section 420 can operate as below in the step of establishing remote connection between the smart phone 100 and the television 200 after the user has operated the smart phone 100 for remote access to the television 200.

That is, in a case where the control section 420 has determined that a record containing the MAC address of the smart phone 100 and the MAC address of the television exists in the database table (i.e., in a case where the television associated with the smart phone 100 has been specified), the control section 420 can transmit the IP address and the connection destination port number of the smart phone 100 to the specified television (television 200) without user authentication.

Note that the control section 420 can cause the apparatus ID of the specified television 200 and the user ID of the smart phone 100 to be stored in the storage section 430 so that the apparatus ID of the specified television 200 and the user ID of the smart phone 100 are associated with each other.

### Modification Example 3

The control section 420 can operate as below in the step of establishing remote connection between the smart phone 100 and the television 200 after the user has operated the smart phone 100 for remote access to the television 200.

That is, when connection with the smart phone 100 has been established, the control section 420 can transmit, to the smart phone 100, html data representing a UI screen containing a user ID input box, a password input box, and a transmit button, without judging whether or not a record including the MAC address of the smart phone 100 and the MAC address of the television exists in the database table.

Then, when the user ID and the password have been inputted on the UI screen displayed on the smart phone 100 and the transmit button has been pressed, the remote reproduction process section 131 can transmit, to the remote access server 400, the user ID and the password thus inputted.

Further, the control section 420 can judge whether or not a record, in which a value of the “user ID” field is identical with the inputted user ID and a value of the “password” field is identical with the inputted password, exists in the database table (i.e., whether or not the user authentication has succeeded).

In a case where the control section 420 has determined that the user authentication has succeeded, the control section 420 can specify, with reference to the value of the “MAC address” field in the relevant record, a television (television 200) which is being connected with the remote access server 400 and is associated with the user ID and the password which have been inputted to the smart phone 100. Then, the control section 420 can transmit the IP address and the connection destination port number of the smart phone 100 to the television 200 thus specified.

Note that the control section 420 can cause the inputted user ID of the smart phone 100 and the apparatus ID of the specified television 200 to be stored in the storage section 430 so that the inputted user ID of the smart phone 100 and the apparatus ID of the specified television 200 are associated with each other.

(Operation of Smart Phone 100 and Television 200 Relating to Remote Reproduction)

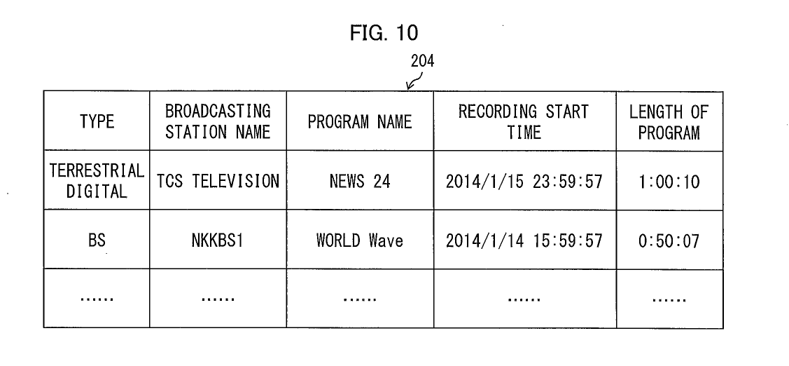

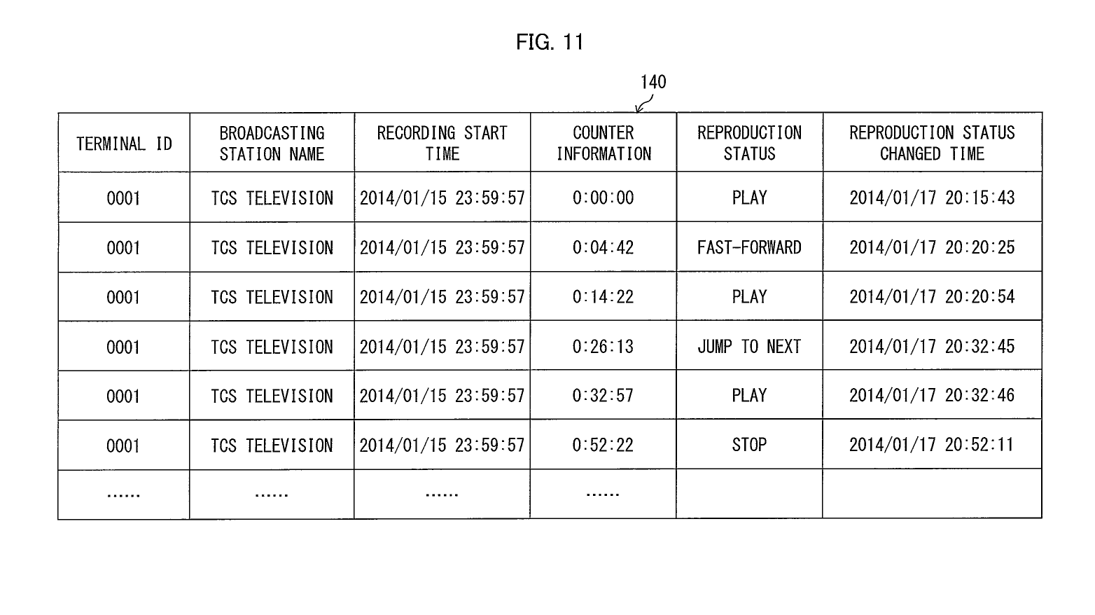

The following description will discuss operation which is carried out by the smart phone 100 and the television 200 after remote connection has been established and relates to remote reproduction, with reference to FIG. 8, (a) of FIG. 9, FIG. 10, and FIG. 11. FIG. 10 is a view exemplifying a recording list held by the television 200. FIG. 11 is a view exemplifying a reproduction log which is generated by the smart phone 100 in a case where the smart phone 100 has accepted an instruction on remotely reproducing a program content listed in the recording list.

First, it is assumed that operation for displaying a recording list has been carried out with respect to a target application.

When the operation has been carried out, the remote reproduction process section 131 requests the television 200 to transmit the recording list.

The remote reproduction managing section 223 of the television 200, which has accepted the request, transmits the recording list illustrated in FIG. 10 to the smart phone 100 (step S201 of FIG. 8).

When the smart phone 100 has received the recording list (step S102 of FIG. 8), the remote reproduction process section 131 causes the recording list to be stored in the storage section 140 and to be displayed on the touch panel display section 150.

Next, it is assumed that the user has selected, from the recording list, a program content to be remotely viewed. The remote reproduction process section 131 of the smart phone 100 which has accepted the selection operation requests the television 200 to transmit the program content which has been selected by the user.

The remote reproduction managing section 223 of the television 200 which has accepted the request transmits the program content, which has been selected by the user, to the smart phone 100 (step S202 of FIG. 8).

When the smart phone 100 has received the program content (step S103 of FIG. 8), the remote reproduction process section 131 starts to reproduce the program content thus received (step S104 of FIG. 8) and the process proceeds to a step S105. Consequently, a reproduction status of the target application is changed from “STOP” to “PLAY” (YES in step S1051 of FIG. 9), and the log generation process section 132 adds a new record to the reproduction log in response to the change in reproduction status (step S1052 of FIG. 9).

Here, the following specifically describes a reproduction log which is generated by the log generation process section 132.

As illustrated in FIG. 11, each of records in the reproduction log of the present embodiment includes a “terminal ID” field, a “broadcasting station name” field, a “recording start time” field, a “counter information” field, a “reproduction status” field, and a “reproduction status changed time” field.

A value of the “terminal ID” field is the terminal ID of the smart phone 100. A value of the “broadcasting station name” field and a value of the “recording start time” field are obtained from the recording list which has been transmitted from the television 200 to the smart phone 100. Values of the “reproduction status” field, the “reproduction status changed time” field, and the “counter information” field are generated by the smart phone 100 itself.

A new record, which is added at a time point when a program content starts to be reproduced, contains (i) a value of the “broadcasting station name” field which value is a text (TCS television) indicating a name of a broadcasting station that has broadcasted the program content and (ii) a value of the “recording start time” field which value is a value (2014/1/15 23:59:57) indicating time at which the television 200 started to record the program content (see FIG. 11). The new record further contains (i) a value of the “reproduction status” field which value is a text “PLAY” indicating the changed reproduction status, (ii) a value of the “reproduction status changed time” field which value is a value (2014/1/17 20:15:43) indicating time at which the reproduction status was changed from “STOP” to “PLAY”, and (iii) a value of the “counter information” field which value is a value (i.e., 0:00:00) of a reproduction counter at the time. Even after the reproduction of the program content has started, the log generation process section 132 adds a new record to the reproduction log each time the reproduction status is changed. Consequently, the storage section 140 is to store, for example, the reproduction log as illustrated in FIG. 11.

After that, it is assumed that the user has carried out operation to turn OFF the power source of the smart phone 100 (i.e., the power source button section 170 is pressed) (YES in step S1053 of (a) of FIG. 9). In response to this operation, the log transmitting process section 133 transmits a file of the generated reproduction log to the log collecting server 300 (step S1054 of (a) of FIG. 9), and the log generation process section 132 newly generates a file of the reproduction log. Then, after the processes are completed, the power source of the smart phone 100 is turned OFF.

Note that the operation to turn OFF the power source is not limited to the pressing of the power source button section 170. The operation to turn OFF the power source can be, for example, (i) operation to touch a particular area (specifically, an area in which a UI part for turning OFF the power source is displayed) in the touch panel display section 150 or (ii) audio operation to input audio for turning OFF the power source to the microphone.

The description above has discussed the operation of the smart phone 100 and the television 200 in relation to remote reproduction.

(Advantageous Effect of Smart Phone 100)

As above described, the smart phone 100 (reproducing device) includes the remote reproduction process section 131 and the log transmitting process section 133.

The remote reproduction process section 131 (obtaining section) obtains a program content from the television 200 by remotely accessing the television 200 which is connected with a home LAN of the user of the smart phone 100. Then, the remote reproduction process section 131 (reproducing section) reproduces the program content thus obtained.

The log transmitting process section 133 (transmitting section) transmits, to the log collecting server 300, a reproduction log that relates to reproduction of the program content carried out by the remote reproduction process section 131.

Therefore, an administrator of the log collecting server 300 can specify a user's remote viewing record by analyzing the reproduction log supplied from the smart phone 100. That is, the smart phone 100 can be used to specify a record of viewing a program content which has been remotely viewed by a user.

Moreover, the administrator of the log collecting server 300 can specify an audience rating of a program content, which has been remotely viewed by users, by analyzing the reproduction log supplied from the smart phone 100 and reproduction logs supplied from a plurality of other reproducing devices which have a remote reproduction function as with the smart phone 100. That is, the smart phone 100 can be used to specify an audience rating of a program content which has been remotely viewed by users.

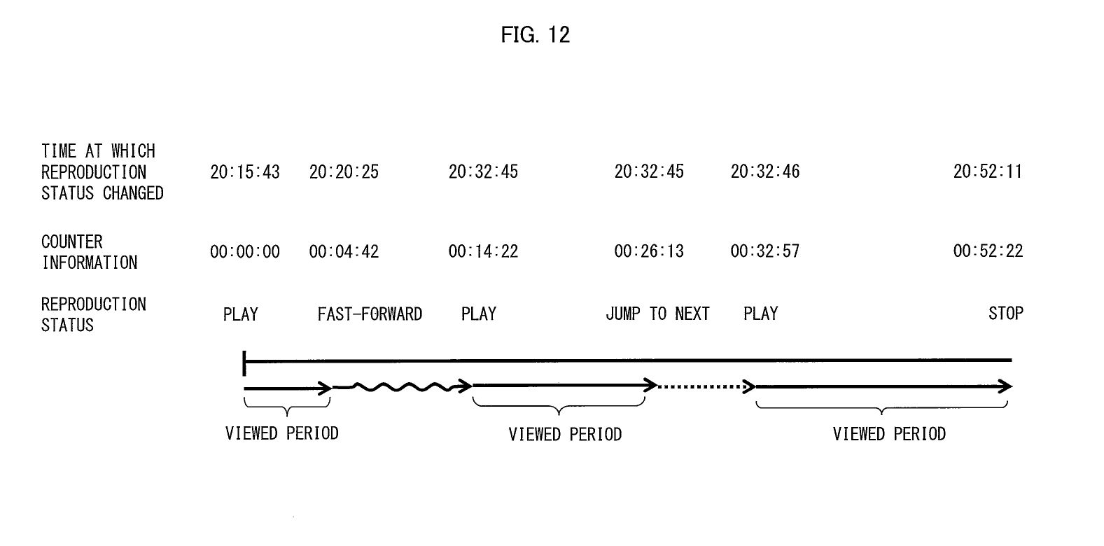

Moreover, by analyzing the reproduction log supplied from the smart phone 100, it is possible to specify which part (scene, corner) of a program content (recorded program content) was viewed by the user (viewer) of the smart phone 100 with the remote reproduction (see FIG. 12). For example, it is possible to specify from the reproduction log of FIG. 11 that “a scene of the program content during normal play (non-trick play) was viewed by the viewer and scenes of the program content during trick play (such as fast-forwarded part and part skipped by “jump to next” operation) were not viewed by the viewer”.

Further, the administrator of the log collecting server 300 can specify an instantaneous audience rating (i.e., an instantaneous audience rating of each of various scenes) of the program content, which has been remotely viewed by users, by analyzing the reproduction log supplied from the smart phone 100 and reproduction logs supplied from a plurality of other reproducing devices having a remote reproduction function as with the smart phone 100.

(Additional Remarks 1)

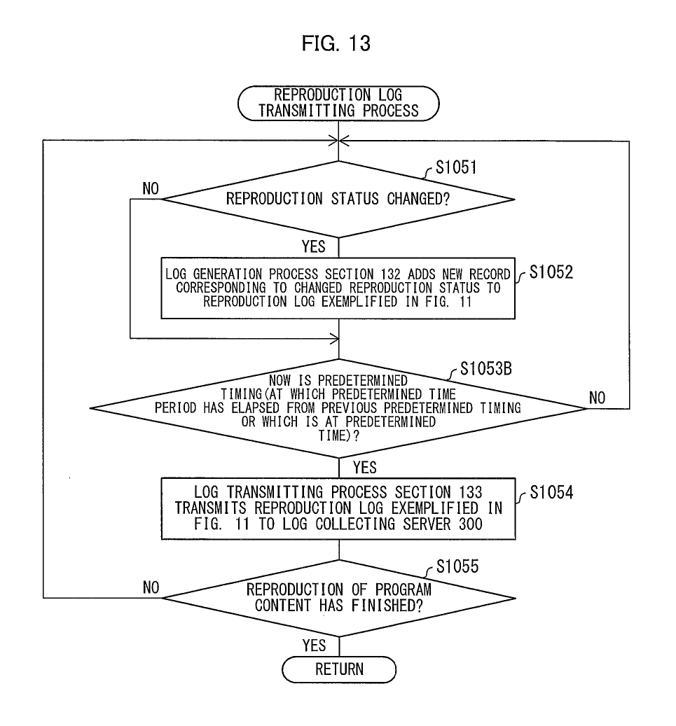

According to the present embodiment, the log transmitting process section 133 transmits the reproduction log in response to the operation to turn OFF the power source of the smart phone 100. Note, however, that the present invention is not limited to this configuration. The following description will discuss another configuration of the present invention with reference to (b) of FIG. 9 and FIG. 13.

(b) of FIG. 9 is a flowchart illustrating another concrete example of the step S105, and FIG. 13 is a flowchart illustrating still another concrete example of the step S105.

For example, until reproduction of a program content is finished (i.e., until it is determined to YES in step S1055 of (b) of FIG. 9), the log transmitting process section 133 can transmit the reproduction log (step S1054A of (b) of FIG. 9) each time the reproduction status is changed (i.e., each time it is determined to YES in step S1053A of (b) of FIG. 9). Note that the reproduction status can be changed in response to operation by the user to change the reproduction status or can be changed automatically. For example, in a case where (i) remote connection is disconnected due to deterioration of communication environment or (ii) reproduction of the program content is finished, the reproduction status automatically changes to “STOP”.

With regard to this, the log transmitting process section 133 can transmit the reproduction log (step S1054A of (b) of FIG. 9) each time user operation to change the reproduction status is carried out (i.e., each time it is determined to YES in step S1053A of (b) of FIG. 9).

Alternatively, until reproduction of the program content is finished (i.e., until it is determined to YES in step S1055 of FIG. 13), the log transmitting process section 133 can carry out a process of transmitting the reproduction log as follows, with reference to time indicated by the built-in clock section 180.

That is, the log transmitting process section 133 can transmit the reproduction log (step S1054 of FIG. 13) each time a predetermined time period (e.g., 1 day, 1 hour, or 1 second) has elapsed or at each predetermined time (e.g., at 12 noon every day or at 12 noon on every Sunday) (i.e., each time it is determined to YES in step S1053B of FIG. 13).

Note that, in this case also, the smart phone 100 adds a new record to the reproduction log each time the reproduction status is changed until reproduction of the program content is finished (step S1051 and step S1052 of FIG. 13).

Alternatively, the log transmitting process section 133 (i) can transmit the reproduction log (step S1054 of (a) of FIG. 9) each time the target application (i.e., the application to reproduce the program content) is activated (i.e., each time it is determined to YES in step S1053 of (a) of FIG. 9) or (ii) can transmit the reproduction log (step S1054 of (a) of FIG. 9) each time the target application is terminated (i.e., each time it is determined to YES in step S1053 of (a) of FIG. 9).

Alternatively, the log transmitting process section 133 (i) can transmit the reproduction log in response to operation which has been carried out for causing the target application to remotely reproduce the program content or (ii) can transmit the reproduction log in response to stoppage of remote reproduction of the program content.

Alternatively, the log transmitting process section 133 (i) can transmit the reproduction log when disconnection of remote connection with the television 200 has been recognized or (ii) can transmit the reproduction log in response to operation which has been carried out for causing the target application to carry out trick play of the program content. Note that the trick play encompasses fast-forwarding, fast-reversing, pause, frame advance, frame reverse, slow reproduction, slow reverse reproduction, chapter jump (previous/next), and/or time-specified jump.

(Additional Remarks 2)

The remote reproduction managing section 223 of the television 200, which has been requested by the smart phone 100 to transmit a program content, can judge whether the program content is (i) a content to be transmitted while being encrypted (i.e., copyright-protected content) or (ii) a content which can be transmitted while being encrypted or not being encrypted (i.e., copyright-unprotected content). Note that the remote reproduction managing section 223 can be configured to deal with (i) a charged content as a content to be transmitted while being encrypted and (ii) a free content as a content which can be transmitted while being encrypted or not being encrypted.

Further, the remote reproduction managing section 223 can notify the smart phone 100 of a judgment result.

The remote reproduction process section 131 of the smart phone 100 thus notified can give, to the television 200, an instruction on whether to encrypt the program content to be transmitted. For example, in a case where the program content which has been requested to the television 200 to transmit is a copyright-protected content, the remote reproduction process section 131 can instruct the television 200 to encrypt and transmit the program content. Alternatively, in a case where the program content is a copyright-unprotected content, the remote reproduction process section 131 can instruct the television 200 to transmit the program content without encrypting the program content.

In a case where the television 200 has been instructed to encrypt and transmit the program content, the remote reproduction managing section 223 can supply the program content to the encrypting section 224. Then, the encrypting section 224 can (i) encrypt the program content with the use of a shared key of the smart phone 100 and the television 200 and (ii) transmit the program content, which has been thus encrypted, to the smart phone 100.

Meanwhile, in a case where the television 200 has been instructed to transmit the program content without encrypting the program content, the remote reproduction managing section 223 transmits the program content to the smart phone 100 without encrypting the program content.

(Additional Remarks 3)

A recording list can contain all of or any of a broadcasting station ID, a channel number, a broadcasting station name, a program name, recording start time, a broadcasting type, a program ID, program start time, information on a length of a program, information indicating whether a program is a charged program or a free program, parental control information, category information, and a file size. The channel number can be a combination of a triple-digit number and a sub-number. For example, in a case where a certain program content listed in the recording list is a program content of a NIHONMARU television (of channel 4), a channel number relating to the program content can be “041-0”.

In the embodiment described above, the smart phone 100 generates a reproduction log relating to remote reproduction of a program content with the use of a broadcasting station name and recording start time of the program content which are contained in the recording list. Note, however, that the present invention is not limited to such a configuration.

For example, the smart phone 100 can generate a reproduction log relating to remote reproduction of a program content with the use of a channel number and program start time which relate to the program content and are contained in a recording list. That is, in order to generate a reproduction log relating to remote reproduction of a program content, the smart phone 100 can (i) extract information that can be used to specify a broadcasting station broadcasting the program content and start time of the program content and (ii) generate a reproduction log with the use of the information thus extracted.

(Additional Remarks 4)

The television 200 can be configured to cause the storage section 204 to store not only program contents but also contents other than program contents (e.g., a movie content taken by the user of the television 200 with the use of a digital video camera). Moreover, the smart phone 100 can be configured to remotely reproduce such a movie content, as well as a program content.

In this case, the smart phone 100 is configured not to generate a reproduction log relating to remote control of the movie content above described.

(Additional Remarks 5)

According to the present embodiment, values of the “counter information” field, the “reproduction status” field, and the “reproduction status changed time” field are contained in a reproduction log. Note, however, that the present invention is not limited to such a configuration.

For example, the reproduction log can be a reproduction log which (i) contains information indicative of time at which a reproduction status of a program content was changed and information indicative of the reproduction status thus changed and (ii) does not contain information indicative of a value of a reproduction counter at the time. Even in such a configuration, the administrator of the log collecting server 300 can specify which part of the program content was viewed by the user of the smart phone 100.

Alternatively, the reproduction log can be a reproduction log which (i) contains information indicative of time at which a reproduction status of a program content was changed and information indicative of a value of a reproduction counter at the time and (ii) does not contain information indicative of the reproduction status thus changed. As described below, even in such a configuration, the administrator of the log collecting server 300 can specify which part of the program content was viewed by the user of the smart phone 100.

With regard to two adjacent records in the reproduction log, in a case where a difference of two values of the “counter information” field is equal to a difference of two values of the “reproduction status changed time” field, it is possible to determine that a scene during a period specified by the two records was viewed by the user of the smart phone 100. For example, with regard to a first record and a second record in the reproduction log illustrated in FIG. 11, two differences, each of which is between two values in the field, are both “4:42”. From this, it is possible to determine that a scene during a period from the beginning to a time point of 4 minutes and 42 seconds of the program content was viewed by the user of the smart phone 100.

On the other hand, with regard to two adjacent records in the reproduction log, in a case where a difference of two values of the “counter information” field is different from a difference of two values of the “reproduction status changed time” field, it is possible to determine that a scene during a period specified by the two records was not viewed by the user of the smart phone 100. For example, with regard to a second record and a third record in the reproduction log illustrated in FIG. 11, a difference of two values in the “counter information” field is “9:40” and a difference of two values in the “reproduction status changed time” field is “0:29”. From this, it is possible to determine that a scene during a period between a time point of 4 minutes and 42 seconds and a time point of 14 minutes and 22 seconds of the program content was not viewed by the user of the smart phone 100.

Therefore, even if the reproduction log illustrated in FIG. 11 does not contain the “reproduction status” field, the administrator of the log collecting server 300 can specify which part of the program content was viewed by the user of the smart phone 100.

(Additional Remarks 6)

According to the present embodiment, the reproducing device of the present invention is exemplified by the smart phone 100. Note, however, that the reproducing device is of course not limited to the smart phone 100. The reproducing device can be, for example, a feature phone, a tablet terminal, a mobile PC, an in-vehicle apparatus (e.g., car navigation apparatus), a television receiver, or a game machine.

(Additional Remarks 7)

In a case where the television 200 is configured to serve as a DLNA (Registered Trademark) server, pairing of the television 200 and the smart phone 100 can be carried out as follows:

That is, in a case where the user (i) has connected the smart phone 100 (via, for example, WiFi connection) to the home local area network with which the television 200 is connected and further (ii) has operated a target application for pairing, the smart phone 100 can detect an apparatus (i.e., the television 200), which serves as the DLNA server, with the use of an apparatus detecting function (Simple Service Discovery Protocol: SSDP) of DLNA.

Then, it is possible that the smart phone 100 (i) is connected to the television 200 thus detected with the use of SSDP and (ii) requests the television 200 to carry out a process for pairing the television 200 and the smart phone 100.

The television 200 which has thus received the request can transmit, to the remote access server 400, a pair of the MAC address of the television 200 and the MAC address of the smart phone 100, and the control section 420 of the remote access server 400 can register, on the database table, a new record that contains the MAC address of the television 200 and the MAC address of the smart phone 100.

### Embodiment 2

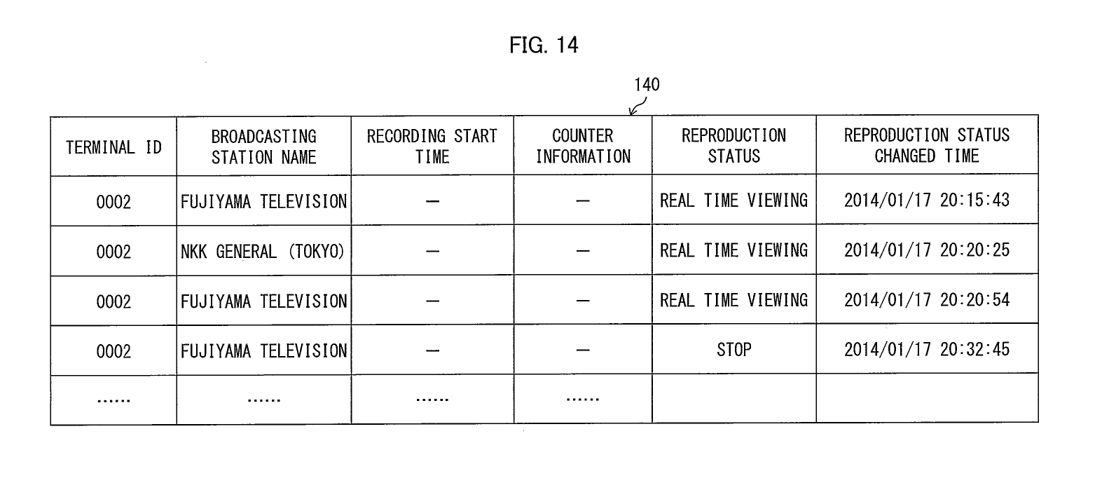

The following description will discuss a reproducing system in accordance with another embodiment of the present invention, with reference to FIG. 14. Note that the reproducing system of the present embodiment has a configuration which is completely identical with that of the reproducing system of Embodiment 1. Therefore, the configuration of the reproducing system is not repeatedly described below. Moreover, for convenience of explanation, the same reference numerals are basically given to constituent members having functions completely or substantially identical to those of the constituent members described in Embodiment 1, and descriptions of such constituent members are omitted.

(Outline of Reproducing System)

The reproducing system of the present embodiment is basically identical with the reproducing system of Embodiment 1. Note, however, that the smart phone 100, which has become able to remotely access the television 200, remotely reproduces a program content that is being received by the television 200. That is, the smart phone 100 is configured to reproduce an on-air program content in real time by remotely accessing the television 200.

Then, the smart phone 100 generates a reproduction log while remotely reproducing the program content, and transmits the reproduction log thus generated to the log collecting server 300.

(Operation of Smart Phone 100 and Television 200 Relating to Remote Reproduction)

The following description will discuss operation which is carried out by the smart phone 100 and the television 200 and relates to remote reproduction after remote connection has been established, with reference to FIG. 14. FIG. 14 is a view exemplifying a reproduction log which is generated by the smart phone 100 in a case where the smart phone 100 has accepted an instruction on remotely reproducing an on-air program content. Note that it is assumed that remote connection between the smart phone 100 and the television 200 has been established with the method described in Embodiment 1.

First, it is assumed that operation for selecting a channel has been carried out with respect to a target application.

When the operation has been carried out, the remote reproduction process section 131 requests the television 200 to transmit a program content of the channel thus selected.

The remote reproduction managing section 223 of the television 200, which has accepted the request, controls the broadcast receiving section 202 to extract the program content of the selected channel from a broadcast wave. The remote reproduction managing section 223 transmits, to the smart phone 100, the program content which has been extracted from the broadcast wave by the demodulating section 203. Note that the program content contains actual data (such as video data and audio data) and meta-data (such as a broadcasting station name).

When the smart phone 100 has received the program content, the remote reproduction process section 131 starts to reproduce the program content thus received. Consequently, a reproduction status of the target application is changed from “STOP” to “REAL TIME VIEWING”, and the log generation process section 132 adds a new record to a reproduction log in response to change of reproduction status or change of reproduced channel.

Here, the following specifically describes a reproduction log which is generated by the log generation process section 132.

As illustrated in FIG. 14, each of records in the reproduction log of the present embodiment includes a “terminal ID” field, a “broadcasting station name” field, a “recording start time” field, a “counter information” field, a “reproduction status” field, and a “reproduction status changed time” field.

A value of the “terminal ID” field is the terminal ID of the smart phone 100. A value of the “broadcasting station name” field is obtained from the meta-data contained in the program content. Values of the “reproduction status” field and the “reproduction status changed time” field are generated by the smart phone 100 itself. Note that values of the “recording start time” field and the “counter information” field are constantly null values.

Even after the reproduction of the program content has started, the log generation process section 132 adds a new record to the reproduction log each time the reproduction status is changed or the reproduction channel is changed. Consequently, the storage section 140 is to store, for example, the reproduction log as illustrated in FIG. 14.

After that, it is assumed that the user has carried out operation to turn OFF the power source of the smart phone 100 (i.e., the power source button section 170 is pressed). In response to this operation, the log transmitting process section 133 transmits a file of the generated reproduction log to the log collecting server 300, and the log generation process section 132 newly generates a file of the reproduction log. Then, after the processes are completed, the power source of the smart phone 100 is turned OFF.

The description above has discussed the operation of the smart phone 100 and the television 200 in relation to remote reproduction.

(Advantageous Effect of Smart Phone 100)

The smart phone 100 of the present embodiment also brings about an effect similar to that of the smart phone 100 of Embodiment 1.

That is, the log collecting server 300 can specify which part of the program content, which was remotely reproduced, was viewed by the user (viewer) of the smart phone 100, by analyzing the reproduction log supplied from the smart phone 100. For example, it is possible to specify from the reproduction log of FIG. 14 that “the viewer viewed a scene from 2014/1/17 20:15:43 to 2014/1/17 20:20:25 and a scene from 2014/1/17 20:20:54 to 2014/1/17 20:32:45 in a program content of a FUJIYAMA television and viewed a scene from 2014/1/17 20:20:25 to 2014/1/17 20:20:54 of a program content of NKK General (Tokyo)”.

From this, the administrator of the log collecting server 300 can specify when and which channel was selected by each of reproducing devices (i.e., which part (scene, corner) of which program was viewed by a user of each reproducing device in real time) by analyzing the reproduction log supplied from the smart phone 100 and reproduction logs supplied from a plurality of other reproducing devices which have a function of remote reproduction as with the smart phone 100.

Further, the administrator of the log collecting server 300 can specify an instantaneous audience rating (i.e., an instantaneous audience rating of each of various scenes) of the program content, which has been remotely viewed by users, by carrying out the above described analysis.

(Additional Remarks)

The log transmitting process section 133 of the smart phone 100 in accordance with the present embodiment can also transmit the reproduction log to the log collecting server 300 at a timing described in (Additional Remarks 1) of Embodiment 1.

Alternatively, the log transmitting process section 133 (i) can transmit the reproduction log in response to operation carried out with respect to the target application for changing a channel or (ii) can transmit the reproduction log in response to operation carried out with respect to the target application for starting real time reproduction.

Alternatively, the log transmitting process section 133 can transmit the reproduction log in response to operation carried out with respect to the target application for stopping real time reproduction.

### Embodiment 3

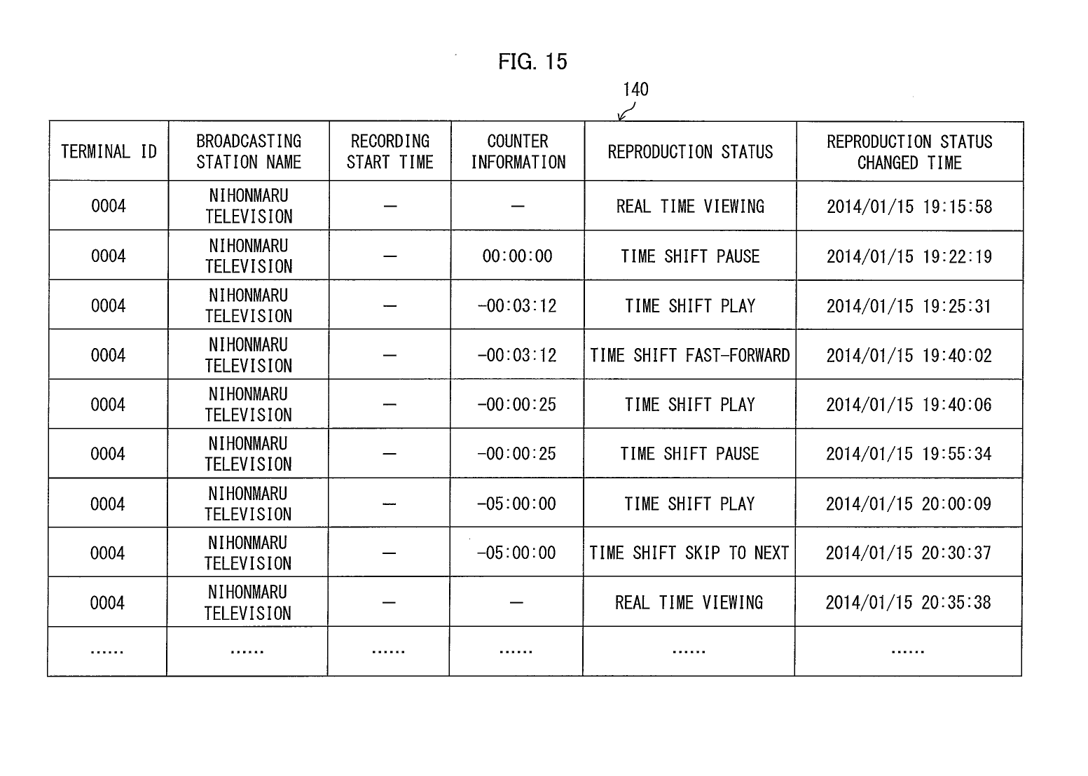

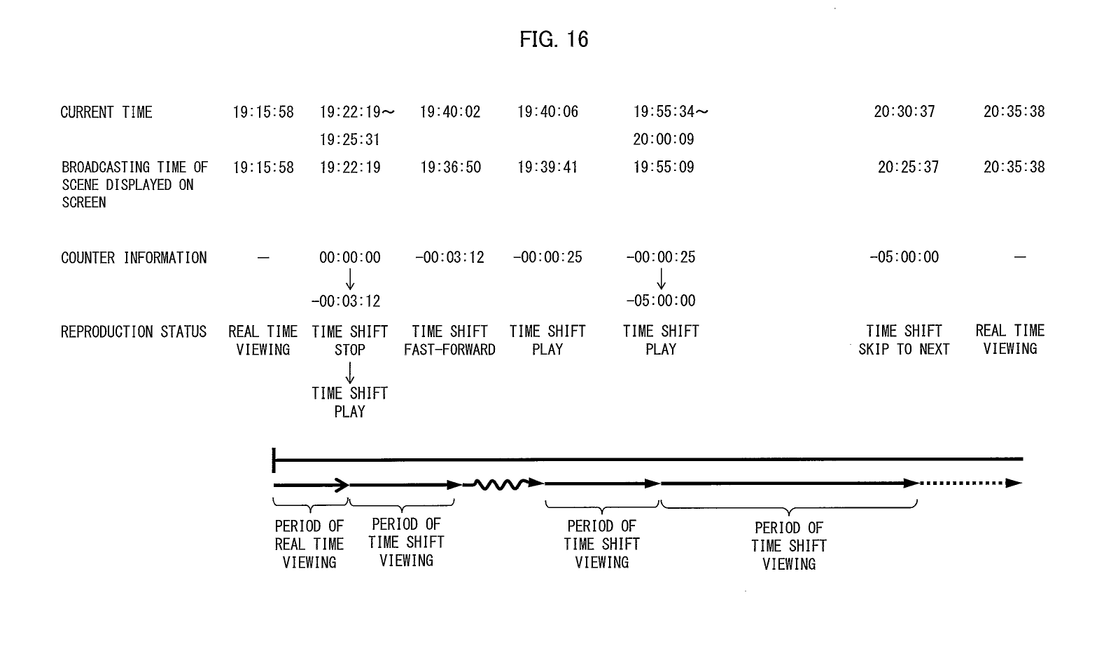

The following description will discuss a reproducing system in accordance with another embodiment of the present invention, with reference to FIGS. 15 and 16. Note that the reproducing system of the present embodiment has a configuration which is completely identical with that of the reproducing system of Embodiments 1 and 2. Therefore, the configuration of the reproducing system is not repeatedly described below. Moreover, for convenience of explanation, the same reference numerals are basically given to constituent members having functions completely or substantially identical to those of the constituent members described in Embodiment 1, and descriptions of such constituent members are omitted.

(Outline of Reproducing System)

The reproducing system of the present embodiment is basically identical with the reproducing system of Embodiment 2. Note, however, that the smart phone 100 can carry out not only real time reproduction but also time shift reproduction while remotely reproducing a program content which is being received by the television 200.

Then, the smart phone 100 generates a reproduction log while remotely reproducing the program content, and transmits the reproduction log thus generated to the log collecting server 300.

(Operation of Smart Phone 100 and Television 200 Relating to Remote Reproduction)

The following description will discuss operation which is carried out by the smart phone 100 and the television 200 and relates to remote reproduction after remote connection has been established, with reference to FIGS. 15 and 16. FIG. 15 is a view exemplifying a reproduction log which is generated by the smart phone 100 when the smart phone 100 has accepted an instruction on remotely reproducing an on-air program content. Note that it is assumed that remote connection between the smart phone 100 and the television 200 has been established with the method described in Embodiment 1.

First, it is assumed that operation for selecting a channel has been carried out with respect to a target application.

When the operation has been carried out, the remote reproduction process section 131 requests the television 200 to transmit a program content of the channel thus selected.

The television 200 transmits the requested program content to the smart phone 100 with a method similar to that described in Embodiment 2. Note that, as with Embodiment 2, the program content contains actual data (such as video data and audio data) and meta-data (such as a broadcasting station name).

When the smart phone 100 has received the program content, the remote reproduction process section 131 starts to reproduce the program content thus received. Consequently, a reproduction status of the target application is changed from “STOP” to “REAL TIME VIEWING”, and the log generation process section 132 adds a new record to a reproduction log in response to change of reproduction status or change of reproduced channel.

Here, the following specifically describes a reproduction log which is generated by the log generation process section 132.

As illustrated in FIG. 15, each of records in the reproduction log of the present embodiment includes a “terminal ID” field, a “broadcasting station name” field, a “recording start time” field, a “counter information” field, a “reproduction status” field, and a “reproduction status changed time” field.

A value of the “terminal ID” field is the terminal ID of the smart phone 100. A value of the “broadcasting station name” field is obtained from the meta-data contained in the program content. Values of the “reproduction status” field, the “reproduction status changed time” field, and the “counter information” field are generated by the smart phone 100 itself. Note that a value of the “recording start time” field is constantly a null value. Moreover, the value of the “counter information” field becomes a null value only during real time reproduction.

Even after the reproduction of the program content has started, the log generation process section 132 adds a new record to the reproduction log each time the reproduction status is changed or the reproduction channel is changed. Consequently, the storage section 140 is to store, for example, the reproduction log as illustrated in FIG. 15.

After that, it is assumed that the user has carried out operation to turn OFF the power source of the smart phone 100 (i.e., the power source button section 170 is pressed). In response to this operation, the log transmitting process section 133 transmits a file of the generated reproduction log to the log collecting server 300, and the log generation process section 132 newly generates a file (empty file) of the reproduction log. Then, after the processes are completed, the power source of the smart phone 100 is turned OFF.

The description above has discussed the operation of the smart phone 100 and the television 200 in relation to remote reproduction.

(Advantageous Effect of Smart Phone 100)

The smart phone 100 of the present embodiment also brings about an effect similar to that of the smart phones 100 of Embodiments 1 and 2.

That is, the log collecting server 300 can specify which part of the program content, which was remotely reproduced, was viewed by the user (viewer) of the smart phone 100, by analyzing the reproduction log supplied from the smart phone 100 (see FIG. 16). For example, it is possible to specify from the reproduction log of FIG. 15 that “a scene from 2014/1/15 19:15:58 to 2014/1/15 19:22:19 was viewed in real time, and a scene from 2014/1/15 19:22:19 to 2014/1/17 19:36:50 and a scene from 2014/1/15 19:39:41 to 2014/1/15 20:25:37 were viewed by time shift viewing”.

From this, the administrator of the log collecting server 300 can specify an instantaneous audience rating (i.e., an instantaneous audience rating of each of various scenes) of the program content, which has been remotely viewed by users, by analyzing the reproduction log supplied from the smart phone 100 and reproduction logs supplied from a plurality of other reproducing devices which have a function of remote reproduction as with the smart phone 100.

(Additional Remarks)

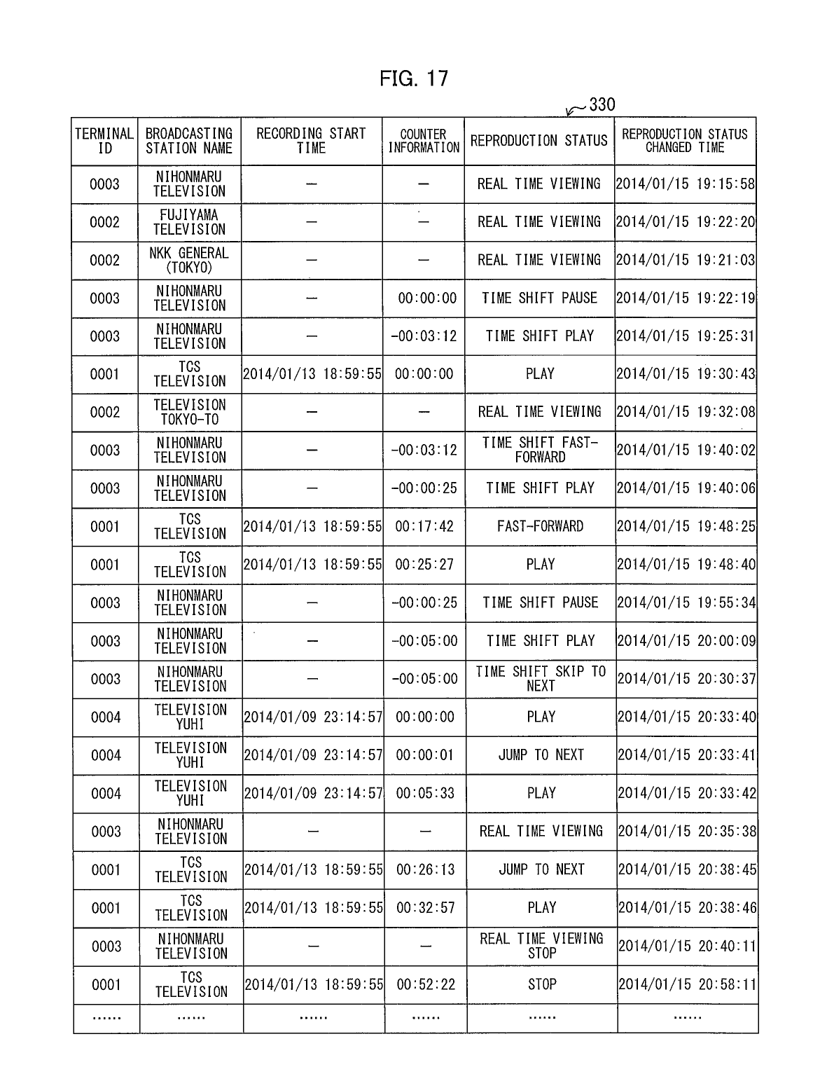

The log collecting server generates view information data as exemplified in FIG. 17 by collecting reproduction logs from a plurality of reproducing devices including the smart phones 100 of Embodiments 1 through 3 and combining the reproduction logs thus collected.

By analyzing the view information data, it is possible to specify an audience rating of each of various programs and an instantaneous audience rating of each of various scenes in each of the various programs, each of which is remotely viewed by users. For example, by analyzing the view information data, the log collecting server 300 can (i) specify the number of terminals which reproduced a program A and (ii) obtain an audience rating of the program A, which was remotely viewed by users, by dividing the specified number by the total number of downloads of a target application.

### Embodiment 4

According to the reproducing system in each of Embodiments 1 through 3, the smart phone 100 remotely accesses the television 200 so as to obtain a program content from the television 200. Note, however, that the present invention is not limited to this configuration.

According to a reproducing system of the present embodiment, a television itself does not have a function to transmit a program content to a smart phone.

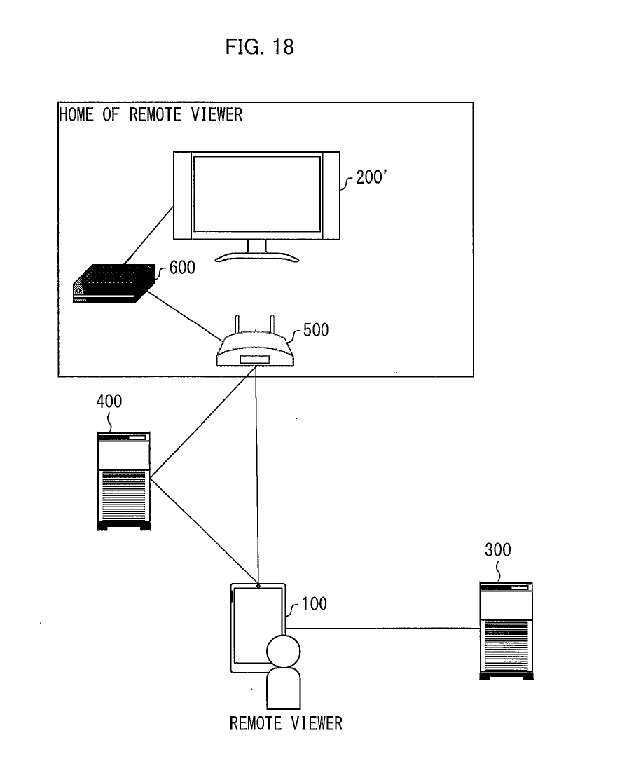

The following description will discuss the reproducing system of the present embodiment with reference to FIG. 18. FIG. 18 is a system block diagram illustrating the reproducing system of the present embodiment.

Note that, for convenience of explanation, the same reference numerals are basically given to constituent members having functions completely or substantially identical to those of the constituent members described in Embodiment 1, and descriptions of such constituent members are omitted.

(Configuration of Reproducing System)

As illustrated in FIG. 18, the reproducing system of the present embodiment includes a smart phone 100, a television receiver 200′ (hereinafter, simply referred to as “television 200′”), a log collecting server 300, a remote access server 400, a router 500, and a remote viewing server 600.

A recording managing section of the television 200′ has a function to record, on the remote viewing server 600, a program content which has been received by the television 200′. In a case where this function is valid, the recording managing section sets the remote viewing server 600 as a recording destination of a program content and a recording list. Meanwhile, a CPU of the television 200′ does not serve as the remote reproduction managing section 223 and the encrypting section 224 described in Embodiment 1.

The remote viewing server 600 is connected with a home local area network of the user of the smart phone 100. The remote viewing server 600 includes a receiving process section (not illustrated). In a case where the above function is valid, the receiving process section receives, from the television 200′, a program content to be recorded and causes the program content to be stored in a storage section (not illustrated). A CPU of the remote viewing server 600 serves as the remote reproduction managing section 223 and the encrypting section 224.

The router 500 is placed in the home of the user, and the router 500 enables communication between the local area network and an external network.

The log collecting server 300 and the remote access server 400 are provided on a cloud side.

The remote access server 400 is used to achieve remote access from the smart phone 100 (slave unit) to the remote viewing server 600 (master unit). The smart phone 100, which has become able to remotely access the remote viewing server 600, remotely reproduces a program content which has been received by the television 200′ and stored in the remote viewing server 600. Then, the smart phone 100 generates a reproduction log while remotely reproducing the program content.

The log collecting server 300 receives, from the smart phone 100, the reproduction log thus generated. Then, the log collecting server 300 (i) generates view information data by combining reproduction logs collected from a plurality of terminals including the smart phone 100 and (ii) specifies a program-viewing record of a user of each terminal and an audience rating of the program by analyzing the view information data.

(Operation of Reproducing System)

The reproducing system of the present embodiment carries out operation for establishing remote connection between the smart phone 100 and the remote viewing server 600. Here, details of the operation are omitted because the operation of the reproducing system in accordance with the present embodiment can be understood by replacing the “television 200” in (Operation carried out by reproducing system for establishing remote connection between smart phone 100 and television 200) of Embodiment 1 with the “remote viewing server 600”.

Moreover, according to the reproducing system of the present embodiment, the smart phone 100 and the remote viewing server 600 carry out operation relating to remote reproduction after the remote connection has been established. Here, details of the operation are omitted because the operation of the reproducing system in accordance with the present embodiment can be understood by replacing the “television 200” in (Operation of smart phone 100 and television 200 relating to remote reproduction) of Embodiment 1 with the “remote viewing server 600”.

(Additional Remarks 1)

The recording managing section of the television 200′ can be configured to surely record, on the remote viewing server 600, a program content to be recorded. In this case, the television 200′ does not need to include the storage section 204.

(Additional Remarks 2)

The recording managing section of the television 200′ can be configured to record a program content, which has been received by the television 200′, on the storage section 204. The recording managing section can be configured to copy or move a program content, which has been recorded on the storage section 204, to the remote viewing server 600.

Further, it is possible that, in a case where the smart phone 100 has accepted operation for remotely reproducing a program content stored in the remote viewing server 600, the remote viewing server 600 carries out a process for establishing remote connection with the smart phone 100 and a process for transmitting data which is necessary for the smart phone 100 to carry out remote reproduction.

### Embodiment 5

Control blocks (in particular, the remote reproduction process section 131, the log generation process section 132, the log transmitting process section 133, the remote reproduction managing section 223, and the encrypting section 224) of the television and the smart phone in accordance with each of Embodiments 1 through 4 may be realized by a logic circuit (hardware) provided in an integrated circuit (IC chip) or the like or may be realized by software as executed by a CPU (Central Processing Unit).

In the case where each of the control blocks is configured by software, each of the television and the smart phone includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Main Points]

The reproducing device (smart phone 100) in accordance with an aspect 1 of the present invention includes: an obtaining section (remote reproduction process section 131) that obtains a program content from an apparatus (television 200), which is connected with a network, by remotely accessing the apparatus; a reproducing section (remote reproduction process section 131) that reproduces the program content which has been obtained by the obtaining section; and a transmitting section (log transmitting process section 133) that transmits, to a server (log collecting server 300), a reproduction log which relates to reproduction of the program content carried out by the reproducing section.

According to the configuration, an administrator of the server can specify a record of viewing a program content which has been remotely viewed by a user.

Therefore, the reproducing device can be used to specify a record of viewing a program content which has been remotely viewed by a user.

According to the reproducing device in accordance with an aspect 2 of the present invention, it is possible in the aspect 1 that the obtaining section obtains, together with the program content, information (broadcasting station name and recording start time) that is usable to specify (i) a broadcasting station broadcasting the program content and (ii) start time of the program content from the apparatus; and the transmitting section transmits a reproduction log which contains (i) the information which has been obtained by the obtaining section together with the program content and (ii) information that indicates time at which a reproduction status of the program content was changed, the reproduction log further containing information that indicates the reproduction status thus changed or information (counter information) that indicates a value of a reproduction counter at the time at which the reproduction status was changed.

According to the configuration, the reproduction log which is to be received by the server contains (i) information that is usable to specify a broadcasting station broadcasting the program content and start time of the program content, (ii) information that indicates time at which a reproduction status of the program content was changed, and the reproduction log further contains information that indicates the reproduction status thus changed or information that indicates a value of a reproduction counter at the time at which the reproduction status was changed.

Therefore, as is clear from (Additional Remarks 5) of Embodiment 1, the administrator of the server can specify an instantaneous audience rating (i.e., an instantaneous audience rating of each of various scenes) of the program content, which has been remotely viewed by users, by analyzing reproduction logs supplied from the plurality of reproducing devices.

Therefore, the reproducing device can be used to specify an instantaneous audience rating of the program content which has been remotely viewed by users.

Note that the reproducing device in accordance with an aspect 3 of the present invention can include, in the aspect 2, a log updating section (log generation process section 132) that adds a record to the reproduction log each time the reproduction status of the program content has been changed, the record containing (i) information which has been obtained by the obtaining section together with the program content and (ii) information that indicates time at which the reproduction status of the program content was changed, and the record further containing information that indicates the reproduction status thus changed or information that indicates a value of the reproduction counter at the time at which the reproduction status was changed.

According to the reproducing device in accordance with an aspect 4 of the present invention, it is possible in the aspect 1 that the transmitting section repeatedly transmits the reproduction log; and the reproduction log transmitted by the transmitting section is a reproduction log that relates to reproduction of the program content carried out from when the transmitting section transmitted a reproduction log last time.

According to the configuration, the reproducing device sequentially transmits the reproduction log to the server and can therefore bring about an effect similar to that of the reproducing device in accordance with the aspect 1 of the present invention, even if an area that can be used to store the reproduction log is small.

Note that, according to the reproducing device in accordance with an aspect 5 of the present invention, it is possible in the aspect 4 that the transmitting section transmits the reproduction log each time a predetermined time period has elapsed or at every predetermined time. Alternatively, according to the reproducing device in accordance with an aspect 6 of the present invention, it is possible in the aspect 4 that the transmitting section transmits the reproduction log each time the reproduction status of the program content has been changed. Alternatively, according to the reproducing device in accordance with an aspect 7 of the present invention, it is possible in the aspect 4 that the transmitting section transmits the reproduction log each time user operation for changing the reproduction status of the program content has been carried out.

Alternatively, according to the reproducing device in accordance with an aspect 8 of the present invention, it is possible in the aspect 4 that the transmitting section transmits the reproduction log each time an application (target application) for reproducing the program content is activated or terminated. Alternatively, according to the reproducing device in accordance with an aspect 9 of the present invention, it is possible in the aspect 4 that the reproducing device includes an operation accepting section that accepts operation for turning OFF a power source of the reproducing device, and, each time the operation accepting section has accepted the operation, the reproduction log is transmitted.

The receiving apparatus (television 200) in accordance with an aspect 10 of the present invention includes: a receiving section (broadcast receiving section 202) that receives a program content; and a transmitting section (remote reproduction managing section 223) that transmits the program content to an external apparatus (smart phone 100), which is connected with the receiving apparatus by remote access, when the external apparatus has requested the program content.

According to the configuration, the receiving apparatus brings about an effect of enabling a user of the reproducing device in accordance with the aspect 1 of the present invention to remotely view a program content.

The reproducing system in accordance with an aspect 11 of the present invention includes a receiving apparatus (television 200, remote viewing server 600), a reproducing device (smart phone 100), and a server (log collecting server 300) which are connected with a network, the receiving apparatus is the receiving apparatus (television 200, remote viewing server 600) in accordance with the aspect 10 of the present invention, and the reproducing device includes: an obtaining section (remote reproduction process section 131) that remotely accesses the receiving apparatus and obtains, from the receiving apparatus, a program content which has been received by the receiving section, a reproducing section (remote reproduction process section 131) that reproduces the program content which has been obtained by the obtaining section, and a log transmitting section (log transmitting process section 133) that transmits, to the server, a reproduction log relating to reproduction of the program content carried out by the reproducing section.

According to the configuration, the reproducing system brings about an effect similar to that of the reproducing device in accordance with the aspect 1 of the present invention.

The reproducing method in accordance with an aspect 12 of the present invention is a method of reproduction carried out by a reproducing device, the method including the steps of: (a) obtaining a program content from an apparatus, which is connected with a network, by remotely accessing the apparatus; (b) reproducing the program content which has been obtained in the step (a); and (c) transmitting, to a server, a reproduction log which relates to reproduction of the program content carried out in the step (b).

According to the configuration, the reproducing method brings about an effect similar to that of the reproducing device in accordance with the aspect 1 of the present invention.

Note that the reproducing device in accordance with each of the aspects 1 through 9 of the present invention can be realized by a computer. In such a case, the present invention encompasses (i) a program which causes the computer to serve as each of the sections of the reproducing device and (ii) a computer-readable storage medium in which the program is stored.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, it is possible to form a new technical feature by combining the technical means disclosed in the respective embodiments.

### INDUSTRIAL APPLICABILITY

The present invention can be suitably applied reproducing devices (such as a smart phone and a tablet terminal) which have a function to remotely reproduce a program content.

### REFERENCE SIGNS LIST

100: Smart phone (reproducing device)
130: Control section
131: Remote reproduction process section (reproducing means)
132: Log generation process section (log updating means)
133: Log transmitting process section (transmitting means, log transmitting means)
170: Power source button section (operation accepting section)
200: Television (receiving apparatus)
202: Broadcast receiving section (receiving means)
220: Control section
223: Remote reproduction managing section (transmitting means)
300: Log collecting server (server)
600: Remote viewing server (receiving apparatus)

1. A reproducing device comprising:
an obtaining section that obtains a program content from an apparatus, which is connected with a network, by remotely accessing the apparatus;
a reproducing section that reproduces the program content which has been obtained by the obtaining section; and
a transmitting section that transmits, to a server, a reproduction log which relates to reproduction of the program content carried out by the reproducing section.

2. The reproducing device as set forth in claim 1, wherein:
the obtaining section obtains, together with the program content, information that is usable to specify (i) a broadcasting station broadcasting the program content and (ii) start time of the program content from the apparatus; and
the transmitting section transmits a reproduction log which contains (i) the information which has been obtained by the obtaining section together with the program content and (ii) information that indicates time at which a reproduction status of the program content was changed, the reproduction log further containing information that indicates the reproduction status thus changed or information that indicates a value of a reproduction counter at the time at which the reproduction status was changed.

3. The reproducing device as set forth in claim 2, further comprising:
a log updating section that adds a record to the reproduction log each time the reproduction status of the program content has been changed, the record containing (i) information which has been obtained by the obtaining section together with the program content and (ii) information that indicates time at which the reproduction status of the program content was changed, and the record further containing information that indicates the reproduction status thus changed or information that indicates a value of the reproduction counter at the time at which the reproduction status was changed.

4. The reproducing device as set forth in claim 1, wherein:
the transmitting section repeatedly transmits the reproduction log; and
the reproduction log transmitted by the transmitting section is a reproduction log that relates to reproduction of the program content carried out from when the transmitting section transmitted a reproduction log last time.

5. The reproducing device as set forth in claim 4, wherein:
the transmitting section transmits the reproduction log each time a predetermined time period has elapsed or at every predetermined time.

6. The reproducing device as set forth in claim 4, wherein:
the transmitting section transmits the reproduction log each time the reproduction status of the program content has been changed.

7. The reproducing device as set forth in claim 4, wherein:
the transmitting section transmits the reproduction log each time user operation for changing the reproduction status of the program content has been carried out.

8. The reproducing device as set forth in claim 4, wherein:
the transmitting section transmits the reproduction log each time an application for reproducing the program content is activated or terminated.

9. The reproducing device as set forth in claim 4, further comprising:
an operation accepting section that accepts operation for turning OFF a power source of said reproducing device,
each time the operation accepting section has accepted the operation, the reproduction log being transmitted.

10. A receiving apparatus comprising:
a receiving section that receives a program content; and
a transmitting section that transmits the program content to an external apparatus, which is connected with said receiving apparatus by remote access, when the external apparatus has requested the program content.

11. A reproducing system comprising a receiving apparatus, a reproducing device, and a server which are connected with a network,
the receiving apparatus being a receiving apparatus recited in claim 10, and
the reproducing device including:
an obtaining section that remotely accesses the receiving apparatus and obtains, from the receiving apparatus, a program content which has been received by the receiving section,
a reproducing section that reproduces the program content which has been obtained by the obtaining section, and
a log transmitting section that transmits, to the server, a reproduction log relating to reproduction of the program content carried out by the reproducing section.

12. A method of reproduction carried out by a reproducing device, said method comprising the steps of:
(a) obtaining a program content from an apparatus, which is connected with a network, by remotely accessing the apparatus;
(b) reproducing the program content which has been obtained in the step (a); and
(c) transmitting, to a server, a reproduction log which relates to reproduction of the program content carried out in the step (b).
